(19) United States
(12) Patent Application Publication
(10) Pub. No.: US 2013/0074131 A1
(43) Pub. Date: Mar. 21, 2013

(54) SYSTEM AND METHOD FOR INTEGRATING AND CONTROLLING WEB-BASED HTML PLAYERS IN A NATIVE CONTEXT

(71) Applicants: Laurent Cerveau, Viroflay (FR); Jonathan Benassaya, Menlo Park, CA (US); Jean Lafleur, Paris (FR); Mathieu Ghaleb, Vaucresson (FR)

(72) Inventors: Laurent Cerveau, Viroflay (FR); Jonathan Benassaya, Menlo Park, CA (US); Jean Lafleur, Paris (FR); Mathieu Ghaleb, Vaucresson (FR)

(73) Assignee: MILESTONE PROJECT, INC., San Francisco, CA (US)

(21) Appl. No.: 13/611,525

(22) Filed: Sep. 12, 2012

Related U.S. Application Data
(60) Provisional application No. 61/535,167, filed on Sep. 15, 2011.

(51) Int. Cl. H04N 21/858; H04N 21/2387

(52) U.S. Cl. 725/88; 725/112

(57) ABSTRACT

Javascript code in an HTML Plug-In identifies a video playback event, from an application programming interface (API) of a video provider, during playback of a video in a web view instantiated within a native environment of a computing device. In response, the Javascript code generates a custom uniform resource locator (URL) for the web view that reflects the identified video playback event and provides the custom URL to native instructions executing in the native environment.

### RELATED APPLICATIONS

This application is related to and claims the benefit of U.S. Provisional Patent Application No. 61/535,167 filed on Sep. 15, 2011, the contents of which are hereby incorporated by reference.

### TECHNICAL FIELD

This disclosure relates to the field of media consumption, and in particular, to integrating and controlling web-based HTML players in a native context.

### BACKGROUND OF THE INVENTION

The number of internet-connected devices (e.g., tablet computers, smartphones, set top boxes, internet-enabled television sets) in use worldwide has soared in recent years, and so has the market for streaming online video. Likewise, more and more video providers have been offering content for display on internet-connected devices. Some of the more well-known online video providers are video aggregators such as Youtube, Vimeo, Dailymotion, among others.

In order to play video content on internet-connected devices such as tablet computers and smartphones, Application Programming Interfaces (APIs) native to such devices use a direct link to the video stream. In addition, most devices use their native video players to display the videos. However, most video providers, such as those noted above, are unwilling to give access to their content via a direct universal resource locator (URL) link, as doing so allows users to download the videos directly and easily store, copy and further distribute such videos. To address this issue, many video providers offer access to their videos via APIs that encapsulate these direct links to the videos and that can only work in the context of a web page in order to prevent viewers from directly accessing the data stream. In order to make accessing the videos even more difficult, the video providers may also use hypertext markup language (HTML) iframes, which hide the implementation code, to communicate with the web browser to display the video in an internet-connected device's native video player.

The contractual terms of service for many video providers further restrict access to the videos. Therefore, while software applications on internet-connected devices play the streaming videos in the native device player, they never have access to the videos directly, nor any information concerning the video playback. Such information can include the download and playback progression of the video and status information of the video (e.g., whether the video is currently being played or is stopped).

### SUMMARY OF THE INVENTION

A system and method for integrating and controlling various web-based HTML players from different video providers in a native context including one or several devices, one or more operating systems and native players, and/or one or more web-based HTML players from one or more video providers is presented in this disclosure.

Embodiments of the present invention relate to a protocol for creating a bridge between an internet-connected device's native video player and a video's streaming web context that enables the internet-connected device to control and monitor the playback of videos provided by the video providers directly from the native environment, while respecting the terms of service of the video providers and the terms of service of the API provider.

Embodiments of the present invention are compatible with all video providers' APIs and terms of service, and therefore, enable uniform display and control of videos regardless of the video source. Embodiments of the present invention may be partly cloud-based and therefore can be updated according to changes made by video providers to their APIs without the need to install any new software on the internet-connected device.

### BRIEF DESCRIPTION OF THE DRAWINGS

The present invention will be more readily understood from the detailed description of exemplary embodiments presented below considered in conjunction with the attached drawings, of which:

FIG. 1a is a flowchart of a block diagram of a system architecture for building a communication protocol between the web environment of the video provider's video delivery service and the native environment in which the video will be played, according to an embodiment.

FIG. 1b is a flowchart of a block diagram of a system architecture for building a communication protocol between the web environment of the video provider's video component and the native environment in which the video will be played, according to an embodiment.

FIG. 1c is a flowchart of a block diagram of a system architecture for building a communication protocol between the web environment of the video provider's video delivery API and the native environment in which the video will be played, according to an embodiment.

FIG. 2 is a flowchart of a method for communicating all information related to the video playback from the video provider's web environment to the native environment, according to an embodiment.

FIG. 3 is a flowchart of a method for controlling the video playback in the video provider's web environment from the native environment, according to an embodiment.

FIG. 4 is a block diagram of a system architecture for integrating several different web-based HTML players in a single native interface with the integration tools stored in cloud servers for on the fly upgrades or updates, according to an embodiment.

FIG. 5 is a block diagram illustrating a computer system in which embodiments of the present invention may operate.

### DETAILED DESCRIPTION OF THE INVENTION

The following description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the scope of the present invention.

The integration of various video players into a single application has to be consistent with various terms of service, including those of the API providers, mobile device providers and/or video or content providers. To this end, only public APIs are generally used. However, playing and controlling video in the native player of an internet-connected device includes accessing the video stream directly. Otherwise, playing the video in the video provider's HTML iframe will result in presenting the controls of the video provider's player to the user in a user interface (e.g., on a display of the device), rather than the native controls. Embodiments of the present invention allow a software application to handle the programming interface with different video providers at a level unseen by viewers and thereby present the same user experience regardless of video source.

### Communication Bridge for Control and Information Synchronization

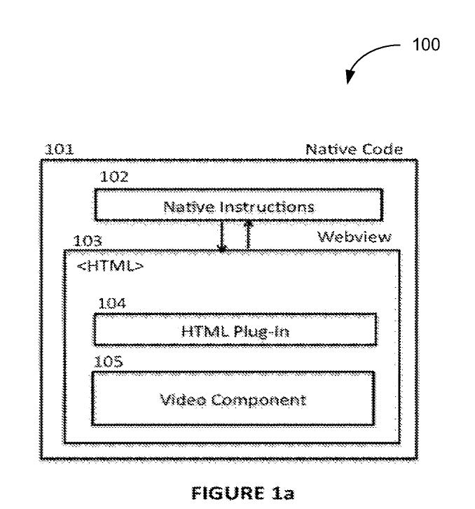

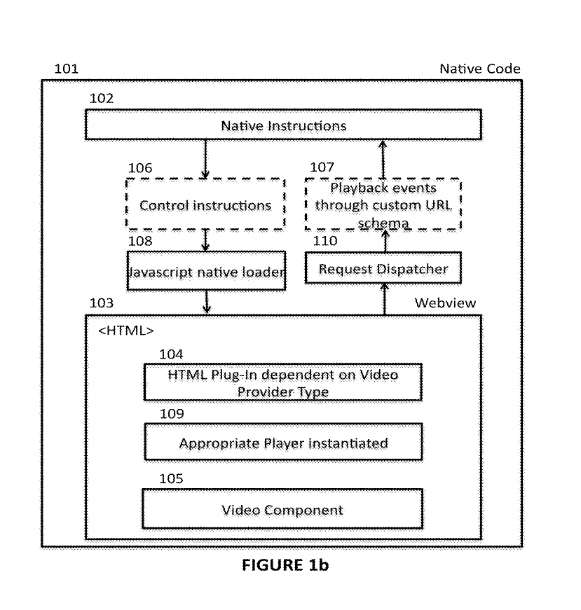

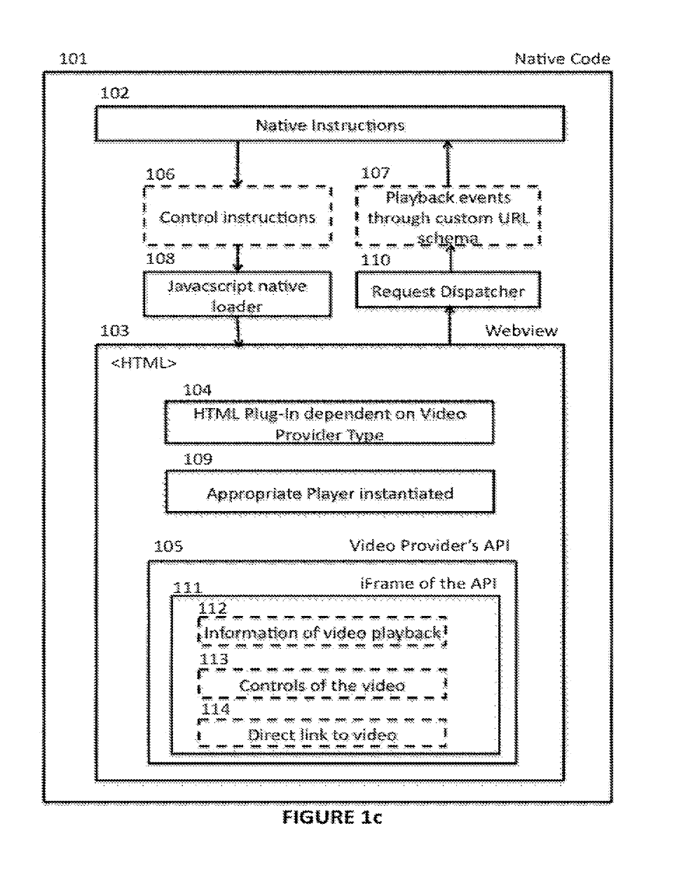

FIG. 1a illustrates an instantiated web view used to play a video or other media content and a communication bridge between the content providers' API and the internet-connected device's native environment. According to an embodiment of the present invention, the video is to be played within a web view in order to not be limited to either the native environment playback controls or to the video's web environment playback controls. This web view 103 may be instantiated within the native environment 101 of the internet connected device 100. The web view 103 may be in communication with both the native environment 101 and native instructions 102 of the internet-connected device 100, as well as the video providers' API and video component 105, in order to gain information about and control over the video in the video provider's web interface. The web view 103 may include a logical instance of the video provider's web interface, such that from the perspective of the video provider, the video is being played via that web interface. The web view 103 may load HTML code that will handle the dispatch and loading of an HTML Plug-In 104 adapted to the video providers' API specifications. In one embodiment HTML Plug-In 104 may include coded instructions (e.g., Javascript code) that enable communication between the native instructions 102 and web view 103.

In one embodiment, internet connected device 100 may include, for example, a personal computer (PC), a tablet PC, a set-top box (STB), a Personal Digital Assistant (PDA), a cellular telephone, a web appliance, a server, or any machine capable of executing a set of instructions. In one embodiment, native environment 101 may additionally include a third party media player (not shown) that makes use of the native controls implemented by native instructions 102. As a result, this third party media player may be able to request and control playback of a video or other type of media (e.g., audio, podcast, etc.) using the controls provided by native instructions 102. The HTML Plug-In 104 may translate these native controls into a Javascript that is compatible with the video provider's API and video component 105 in the web view 103. Thus, the native controls from native instructions 102 can be used to control the video being played within web view 103, where it is not subject to the restrictions of the native environment 101. Additional details of this process will be described below.

FIG. 1b illustrates an embodiment of the present invention in which the communication of playback control instructions between native instructions 102 and web view 103 is made through a Javascript native loader 108 and an interpreter of the control instructions 106. The communication between web view 103 and native instructions 102 may be made through the use of a custom HTML scheme 107 and request dispatcher 110. The request dispatcher 110 may dispatch playback events between the HTML code in web view 103 and the native instructions 102.

According to an embodiment of the present invention, the video provider's API allows direct access to the video link (e.g., podcasts). The HTML Plug-In 104 may instantiate a full HTML5 player 109 appropriate for the video provider. For example, in one embodiment, in which Youtube is the video provider, the HTML Plug-In 104 may instantiate the Youtube player that uses the public iframe-based API from Youtube. In another embodiment, in which Dailymotion is the video provider, the HMTL Plug-In 104 may instantiate the Dailymotion player 109 using the public API from Dailymotion. In yet another embodiment, in which Vimeo is the video provider, the HTML Plug-In 104 may instantiate the Vimeo player 109 that uses the public Froogaloop based API from Vimeo. Javascript code in the HTML Plug-In 104 may enable the proper instantiation of each player 109. One having ordinary skill in the art will appreciate that the HTML Plug-In 104 may be used with a variety of suitable video providers assuming such delivery service is controlled by HTML code.

In one embodiment, a user may enter playback commands (e.g., play, pause, stop, rewind, fast forward, seek, etc.) using the controls implemented by native instructions 102. The command may be made using, for example, a third party media player running in native environment 101. In response, the native instructions 102 may issue control instructions 106 to web view 103. In one embodiment, Javascript native loader 108 translates the control instructions 106 into Javascript code which is written into the HTML Plug-in 104 in web view 103. The Javascript code can interact with the video component and provider API 105 to control playback of the video in the instantiated media player 109.

In one embodiment, upon execution of the playback command on the video, request dispatcher 110 notifies native instructions 102 of the playback event by providing a custom URL 107 to native instructions 102. In one embodiment, the custom URL 107 indicates the playback status of the video in web view 103, and thereby indicates whether the playback command was successfully executed. Native instructions 102 can decode the custom URL 107 to determine the current status of the video in web view 103 and issue any appropriate subsequent commands. In one embodiment, the content provider notifies the Javascript code running in the web view 103 of the change in playback status. In response, the Javascript code may try to change the URL of the web view 103 to custom URL 107. The request dispatcher 110 may notify native instructions 102 of the change in the URL of the web view 103, and the native instructions 102 can get information pertaining to the video status from custom URL 107. In one embodiment, native instructions 102 may then cancel the request to change the URL of web view 103, so that webview 103 does not actually load the web page associated with the new URL.

FIG. 1c shows how video providers may offer access to their video via an API 105. To help control access to the videos, many video providers use HTML iframes 111 containing embedded Javascript code, which communicates with the web to deliver video control 113 and transfer information 112 concerning video playback. Such information may comprise, but is not limited to, the current time and duration of the video, the status of the video, if it is ready to play, ended or if an error occurred when trying to play the video. The iframe 111 may also include a direct link 114 to the video, such as an URL, in some embodiments.

In one embodiment, the direct link URL 114 is unique to the current status of the video. Thus, the transfer information 112 regarding video playback may be reflected in the URL 114. If the controls 113 affect the playback of the video (e.g., by fast-forwarding to a later point in the video), a new URL 114 may be generated reflecting the current position of the video. Request dispatcher 110 may provide this URL 114 to native instructions 102 as custom URL 107. As discussed above, native instructions 102 may decode the custom URL 107 to determine the status of the video playback in web view 103.

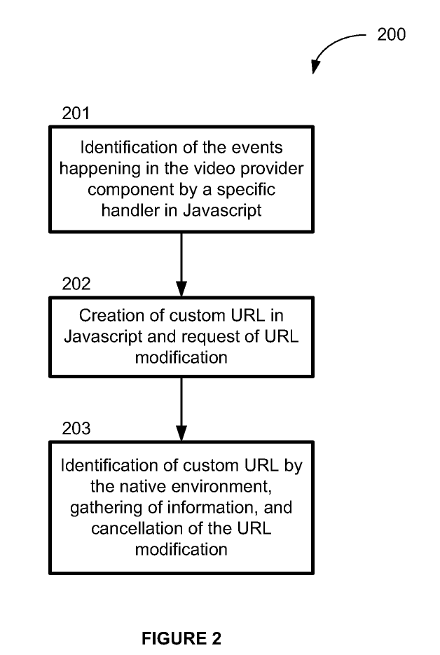

FIG. 2 illustrates how a communication bridge is enabled to listen to all events happening in the video provider's environment and pass such information to the internet-connected device's native environment, according to an embodiment of the present invention. The method 200 may be performed by processing logic that comprises hardware (e.g., circuitry, dedicated logic, programmable logic, microcode, etc.), software (e.g., instructions run on a processor to perform hardware simulation), firmware, or a combination thereof. In one embodiment, method 200 may be performed by HTML Plug-In 104, as shown in FIGS. 1a-1c.

In one embodiment, at block 201, a specific handler, such as HTML Plug-In 104, identifies all events coming from the video provider's web interface directed towards an external destination such as other web interfaces. For example, the events may include a change in the status of the video playback including, for example, starting the video, stopping the video, pausing the video, fast forwarding the video, rewinding the video, loading the video, controlling the volume of the video, seeking within the video, resizing the video, controlling playback quality (i.e., video definition), going to the next or previous video, getting the status of the video (e.g., such as playing coverage, buffering coverage, playback status (pause, play or buffering), player error, ads starting/ending) and/or additional changes in the status of the video playback. In one embodiment, these actions are limited by the video provider's API. If the video provider enables the ability to skip advertisements from the API, then this may be an additional action that changes the status of the video playback. The specific handler intercepts these events and, at block 202, creates custom URLs for each of those events. As discussed above, any change of the status information 112 of video play back may result in the generation of a new URL 114. This unique URL 114 may indicate the current status of the video playback. In addition, the Javascript code in web view 103 may request that the URL for web view 103 may be changed to URL 114. At block 203, the request dispatcher 110 identifies these custom URLs and handles them as they are intended to in order to take into account all information coming from the video provider's web interface. The request dispatcher provides the custom URL to native instructions 102, which may decode the URL to determine the status of the video. This methodology allows for access to all events related to the video (e.g., playback) that are not accessible if the video is simply played by the player of the video provider. The URL modification is cancelled by the native environment 101 so that the web view 103 doesn't load the custom URL 114.

By way of example and not limitation, the case of the HTML5 video player is considered. In a first step, the HTLM5 video events linked to the <video> object are bound to the local Javascript function. With respect to the “pause” event, the binding with JQuery would be done through a call to:

$(“video”).bind(′pause′, function(event) {

onPlayerStateChange(HTML5.PlayerState.PAUSED);

});

Then in the onPlayerStateChange method, the window.location would be set with the custom URL schema:
window.location=‘ajax://statechange?state=’+state;

At the native level, this call is intercepted and recognized as a custom URL schema 107. No action is taken on the location of the web view, and the “pause” event is propagated to other parts of the native application.

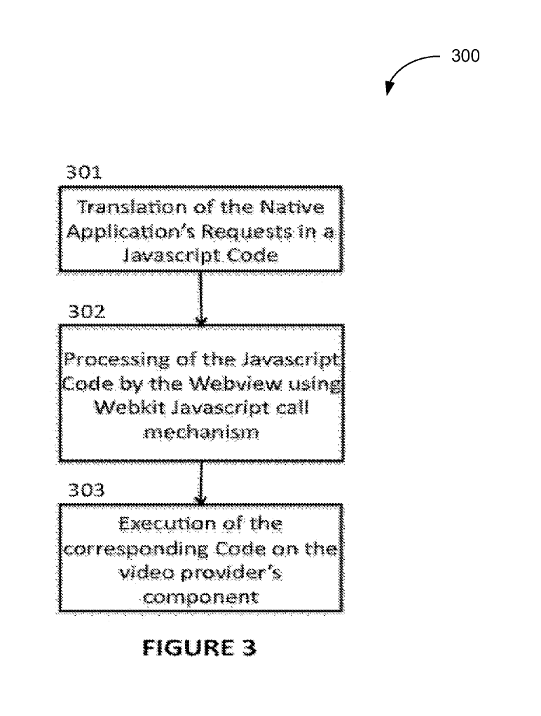

FIG. 3 illustrates the process by which all native instructions are sent to the video provider's web interface in order to control the video playback from the native web view. The method 300 may be performed by processing logic that comprises hardware (e.g., circuitry, dedicated logic, programmable logic, microcode, etc.), software (e.g., instructions run on a processor to perform hardware simulation), firmware, or a combination thereof. In one embodiment, method 300 may be performed by HTML Plug-In 104, as shown in FIGS. 1a-1c.

In one embodiment, at block 301, the native code offers tools to formulate instructions or requests in Javascript. For example, Javascript native loader 108 may receive control instructions 106 from native instructions 102. At block 302, the Javascript requests may then be transmitted to the web environment through the Javascript native loader 108. Javascript native loader 108 may generate Javascript instructions based on the control instructions 106, and load the Javascript instructions into HTML Plug-In 104 in web view 103. At block 303, the Javascript instructions may be used to execute the Javascript request in the video provider's web interface from within the Javascript WebView environment. HTML Plug-In 104 may execute the Javascript requests to interact with the video provider's API 105. This methodology may be used to trigger playback controls for the video in the web view 103.

According to an embodiment of the present invention, a communication bridge is built between the native instructions 102 (as shown in FIGS. 1a-1c) in the internet-connected device's native environment 101 and the video provider's web view 103. Such communication bridge enables the native environment 101 to control the video and to be synchronized with all information available in the video provider's web interface 103 including, without limitation, current time and duration of the video, the status of the video, or if an error occurred when trying to play the video. The integration into a native environment, combined with the control of loaded HTML and cascading style sheets (CSS) enables the application software developers to size, orient, resize or reorient the native web view in any suitable manner.

### Integration of Multiple Players

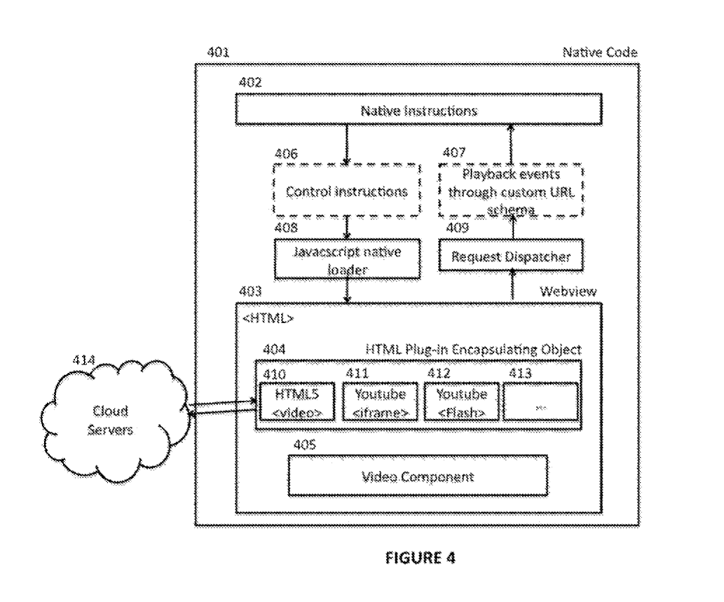

Embodiments of the present invention allow users and developers to control how streaming videos are experienced in a native internet-connected device environment by controlling web-based HTML players. FIG. 4 illustrates an embodiment of the present invention in which multiple web-based HTML players can be integrated in a single interface.

Each HTML player 410, 411, 412, and 413 has a corresponding dedicated Javascript plug-in 404. For example, the <video> HTML5 player 410 may be instantiated if the video is a podcast; the Youtube <iframe> player 411 may be instantiated for Youtube's videos dedicated to mobile devices, and the Youtube Flash player 412 may be instantiated for Youtube's Flash-based videos (<embed> or <object> tag). When the respective player's HTML code is loaded, the appropriate HTML Plug-In 404 is also loaded to control the corresponding player. This enables the creation of a single interface in which videos from different video providers can be played, by accessing video component and API 405, thereby unifying the playback experience on a single device.

Similarly to the embodiments, discussed above, native instructions 402 executing in native environment 201 may provide control instructions 406 to web view 403. Javascript native loader 408 may convert the control instructions 406 to Javascript code which is written into the HTML Plug-In 404. This Javascript code may interact with the video component and API 405 to control playback of the video in the corresponding player 410-413. Upon a change in the status of the video playback, request dispatcher 409 may provide a custom URL 407 to native instructions 402 indicating the current status. Native instructions 402 may decode the custom URL to determine the status information.

### Remote Updating and Upgrading

According to an embodiment of the present invention, the Javascript code to instantiate the proper player 410-413 and the HTML Plug-In Encapsulating Object 404 may be loaded from cloud servers 414. This enables remote upgrading or updating of the HTML and Javascript code without having to release a new version of the internet-connected device's application software. This is especially useful for staying current with updates that video provider's may make to their APIs.

### Computer Hardware Platform

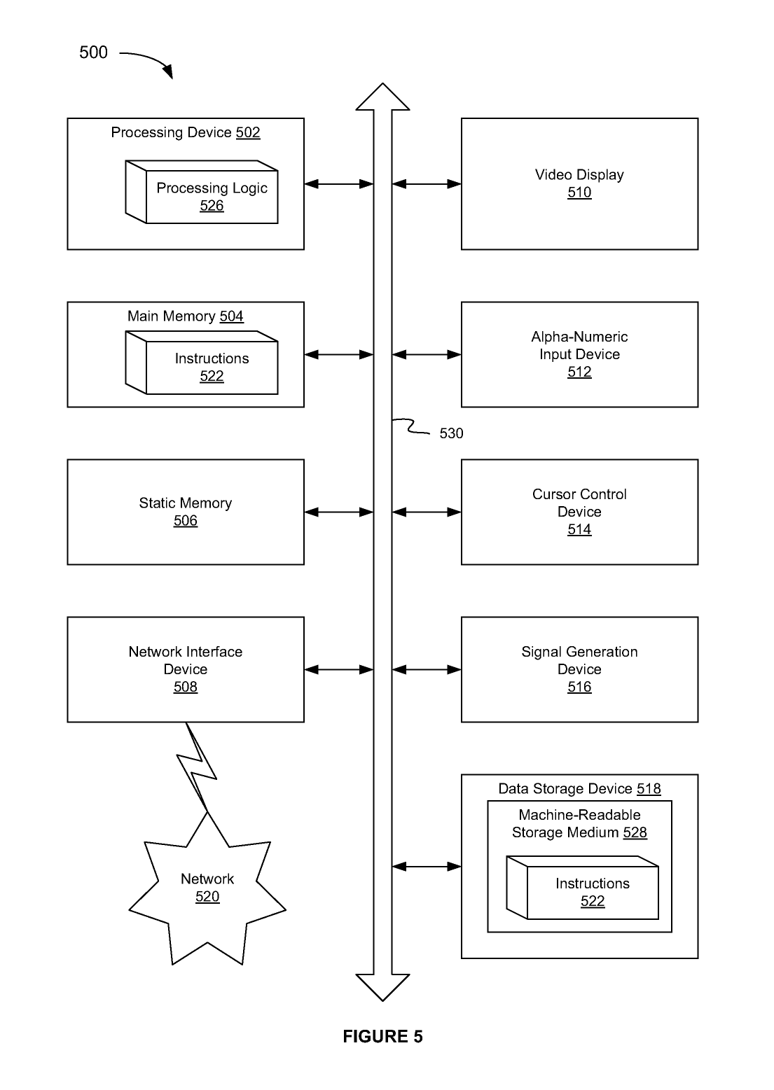

FIG. 5 illustrates a diagrammatic representation of a machine in the exemplary form of a computer system 500 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 500 may be representative of a user device 100 including native code 101 or 401, as described above.

The exemplary computer system 500 includes a processing device 502, a main memory 504 (e.g., read-only memory (ROM), flash memory, dynamic random access memory (DRAM) (such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 502 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute processing logic 526 for performing the operations and steps discussed herein.

The computer system 500 may further include a network interface device 508. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 516 (e.g., a speaker).

The data storage device 518 may include a machine-accessible storage medium 528, on which is stored one or more set of instructions 522 (e.g., software) embodying any one or more of the methodologies of functions described herein. The instructions 522 may also reside, completely or at least partially, within the main memory 504 and/or within the processing device 502 during execution thereof by the computer system 500; the main memory 504 and the processing device 502 also constituting machine-accessible storage media. The instructions 522 may further be transmitted or received over a network 520 via the network interface device 508.

The machine-readable storage medium 528 may also be used to store instructions to perform a method for integrating and controlling web-based HTML players in a native context, as described herein. While the machine-readable storage medium 528 is shown in an exemplary embodiment to be a single medium, the term “machine-readable storage medium” should be taken to include a single medium or multiple media (e.g., a centralized or distributed database, and/or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

What is claimed is:

1. A method comprising:
identifying a video playback event, from an application programming interface (API) of a video provider, during playback of a video in a web view instantiated within a native environment of a computing device;
generating, by a processing device, a custom uniform resource locator (URL) for the web view that reflects the identified video playback event; and
providing the custom URL to native instructions executing in the native environment.

2. The method of claim 1, wherein Javascript code executing within an HTML Plug-In of the web view identifies the video playback event.

3. The method of claim 2, wherein the Javascript code generates the custom URL for the web view.

4. The method of claim 2, wherein the HTML Plug-In is specific to the video provider.

5. The method of claim 1, wherein the video playback event comprises at least one of starting the video, stopping the video, pausing the video, fast forwarding the video, rewinding the video, loading the video, controlling a volume of the video, seeking within the video, resizing the video, controlling playback quality of the video, going to a next or previous video, determining a status of the video, and skipping an advertisement in the video.

6. The method of claim 1, further comprising:
requesting a modification of a URL associated with the web view to be changed to the generated custom URL.

7. The method of claim 6, further comprising:
receiving, from the native instructions, a request to cancel the modification of the URL associated with the web view.

8. The method of claim 1, wherein the native instructions are configured to decode the custom URL to determine the status of the video playback in the web view.

9. The method of claim 1, further comprising:
receiving Javascript instructions based on control instructions from native controls in the native environment; and
executing the Javascript instructions on the API of the video provider to initiate the video playback event.

10. A computing device comprising:
a processing device;
a memory coupled to the processing device; and
an HTML Plug-In, executable by the processing device from the memory, to:
identify a video playback event, from an application programming interface (API) of a video provider, during playback of a video in a web view instantiated within a native environment of the computing device;
generate a custom uniform resource locator (URL) for the web view that reflects the identified video playback event; and
provide the custom URL to native instructions executing in the native environment.

11. The computing device of claim 10, wherein Javascript code executing within the HTML Plug-In of the web view identifies the video playback event.

12. The computing device of claim 11, wherein the Javascript code generates the custom URL for the web view.

13. The computing device of claim 10, wherein the HTML Plug-In is specific to the video provider.

14. The computing device of claim 10, wherein the video playback event comprises at least one of starting the video, stopping the video, pausing the video, fast forwarding the video, rewinding the video, loading the video, controlling a volume of the video, seeking within the video, resizing the video, controlling playback quality of the video, going to a next or previous video, determining a status of the video, and skipping an advertisement in the video.

15. The computing device of claim 10, the HTML Plug-In further to:
request a modification of a URL associated with the web view to be changed to the generated custom URL.

16. The computing device of claim 15, the HTML Plug-In further to:
receive, from the native instructions, a request to cancel the modification of the URL associated with the web view.

17. The computing device of claim 10, wherein the native instructions are configured to decode the custom URL to determine the status of the video playback in the web view.

18. The computing device of claim 10, the HTML Plug-In further to:
receive Javascript instructions based on control instructions from native controls in the native environment; and
execute the Javascript instructions on the API of the video provider to initiate the video playback event.

19. A non-transitory machine-readable storage medium storing instructions which, when executed, cause a processing device to perform a method comprising:
identifying a video playback event, from an application programming interface (API) of a video provider, during playback of a video in a web view instantiated within a native environment of a computing device;
generating, by the processing device, a custom uniform resource locator (URL) for the web view that reflects the identified video playback event; and
providing the custom URL to native instructions executing in the native environment.

20. The non-transitory machine-readable storage medium of claim 19, wherein Javascript code executing within an HTML Plug-In of the web view identifies the video playback event.

21. The non-transitory machine-readable storage medium of claim 20, wherein the Javascript code generates the custom URL for the web view.

22. The non-transitory machine-readable storage medium of claim 20, wherein the HTML Plug-In is specific to the video provider.

23. The non-transitory machine-readable storage medium of claim 19, wherein the video playback event comprises at least one of starting the video, stopping the video, pausing the video, fast forwarding the video, rewinding the video, loading the video, controlling a volume of the video, seeking within the video, resizing the video, controlling playback quality of the video, going to a next or previous video, determining a status of the video, and skipping an advertisement in the video.

24. The non-transitory machine-readable storage medium of claim 19, the method further comprising:
requesting a modification of a URL associated with the web view to be changed to the generated custom URL.

25. The non-transitory machine-readable storage medium of claim 24, the method further comprising:
receiving, from the native instructions, a request to cancel the modification of the URL associated with the web view.

26. The non-transitory machine-readable storage medium of claim 19, wherein the native instructions are configured to decode the custom URL to determine the status of the video playback in the web view.

27. The non-transitory machine-readable storage medium of claim 19, the method further comprising:
receiving Javascript instructions based on control instructions from native controls in the native environment; and
executing the Javascript instructions on the API of the video provider to initiate the video playback event.

28. A method comprising:
receiving a playback command for playback of media data, the playback command received in a native format through native media player controls in a native environment of a computing device;
translating the playback command from the native format to a format supported by a web-based HTML media player running in a web view instantiated within the native environment of the computing device; and
controlling, based on the translated playback command, the playback of the media data in the web-based HTML media player.

29. The method of claim 28, wherein translating the playback command from the native format to the format supported by the web-based HTML media player comprises:
generating Javascript instructions based on the playback command; and
loading the Javascript instructions into an HTML Plug-In in the web view.

30. The method of claim 28, wherein controlling the playback of the media data comprises making a call to an application programming interface (API) provided to the web view by a provider of the media data.
